(19) United States
(12) Patent Application Publication
(10) Pub. No.: US 2007/0050090 A1
(43) Pub. Date: Mar. 1, 2007

(54) Calibration method for improving the accuracy of a robotic measuring system with joint configuration dependent performance

(76) Inventors: Yunquan Sun, Windsor, CT (US); Qing Tang, Windsor, CT (US)

Correspondence Address: Kenneth Onyema;Cambridge Lawyers Group, LLC, 929 Massachusetts Avenue, Level 01, Cambridge, MA, 02139, US

(21) Appl. No.: 11/217,968

(22) Filed: Sep. 1, 2005

(51) Int. Cl. G06F 19/00

(52) U.S. Cl. 700/254; 700/245

(57) ABSTRACT

Industrial robots have been widely used in industrial applications such as welding, and assembly. However, the application of the robots to precision manufacture is limited by their accuracy. As a highly non-linear system, the positioning accuracy of a robot varies with the configuration of the joints or the angular positions as well as translational positions of its joints. This results in a mechanical system of a low accuracy, but very high repeatability. This invention is about an innovative approach that will improve the accuracy of a robotic measuring system to the level of the repeatability of the robot. It is a calibration method for improving the accuracy of a robotic measuring system with joint configuration dependent performance. With such an increased measuring accuracy, the robotic measuring system can be used in many industrial applications requiring a robotic measuring system of high accuracy. One such an application is the automated measurement of the orientations and positions of many holes located on the surface of a part.

### BACKGROUND OF THE INVENTION

In the most general terms, this invention relates an approach to increase the accuracy of an industrial robot for inspection based on relative calibration for certain robot joint configurations.

In some industrial applications such as inspection of holes on a part the accuracy requirements (around 0.1 mm) exceed what the robot can provide. This limits the applications of the robot in this area.

Inaccuracy of the robot is mainly due to the robot joint mechanical tolerance, arm length deformation, gearbox backlash and so on. When the robot has the large joint angle changes normally a few millimeters error will be observed. This error affects the accuracy of the work object measurement as well as the tool center point (TCP) calibration.

However although the overall accuracy of the robot is relatively low, it has much higher repeatability (i.e. 50 micros). When the robot moves in a small area and certain joint configurations it behaves high repeatability and high accuracy. The goal of calibration is to increase the robot accuracy approaching to its repeatability in a small working volume. It has been found that when the robot has the translation only it can maintain the high accuracy (close to its repeatability in the small area). For translation almost all the joints will change to make a linear motion. However they only have small joint angle changes.

### SUMMARY OF THE INVENTION

Since the robot accuracy can be maintained if the robot has only small joint angle changes, in the application such as inspection of holes in a part we can divide hundreds holes into zones. For each zone the robot can reach all the holes for inspection and machining with small joint angle variations. The calibration is conducted with a master or dummy work piece for all different zones. The following is the procedure.

a Making a Masterwork Piece.

The master work piece is selected that is similar to the work piece that will be inspected. The master piece can be one under which all the hole locations are known. The location of all the holes on the master work piece is determined precisely. They are considered as the theoretical values.

b Determining the Work Zone

Group all the holes on the working piece into individual zones. In each zone all the hole positions can be inspected with small robot joint angle changes.

c Measurement of the Master Piece

Use the vision system (or other measurement tool) to measure the positions of all the holes on the master piece. First use the vision system to measurement some geometry feature and create the work object CS based on the measured geometry. All the measurement will be based on this work object CS.

d Transformation Matrix is Formed Based on Measured Data Set and Theoretical Data (Calibration Matrix)

A transform matrix is formed based on the measured hole positions and their theoretical values for each individual zone. This matrix will be used to compensate for the measurement error due to the robot tolerance.

e Measurement of the Work Piece Under Inspection.

Place the work piece under inspection at the same location as the master work piece. Run the same robot program to create the work object coordinate system (CS). Measure all the cooling holes on the part. During the measurement try to keep the same robot joint configuration as for the master piece for each individual zone.

f Correct the Measurement Results with Calibration Matrix

Due to the robot error the measured hole positions may not be accurate. Multiplying the measured results by the calibration matrix performs the correction.

### BRIEF DESCRIPTION OF THE DRAWINGS

FIG. 1 shows all the holes on the working piece grouped into individual zones.

FIG. 2 is a schematic overview of the referred measuring system for implementing the present invention.

FIG. 3 shows the theoretical and the measured positions of the holes on one specific zone of the master work piece. Then the calibration matrix for this specific zone can be determined

FIG. 4 shows the measured and the calibrated positions of the corresponding holes on the work piece at the same location as the master work piece.

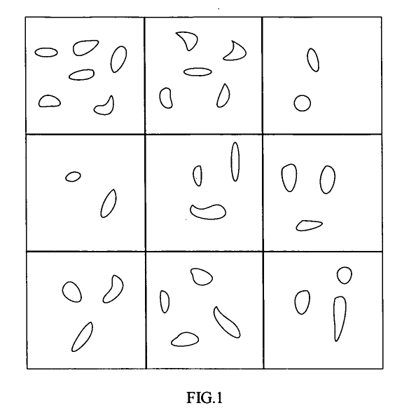

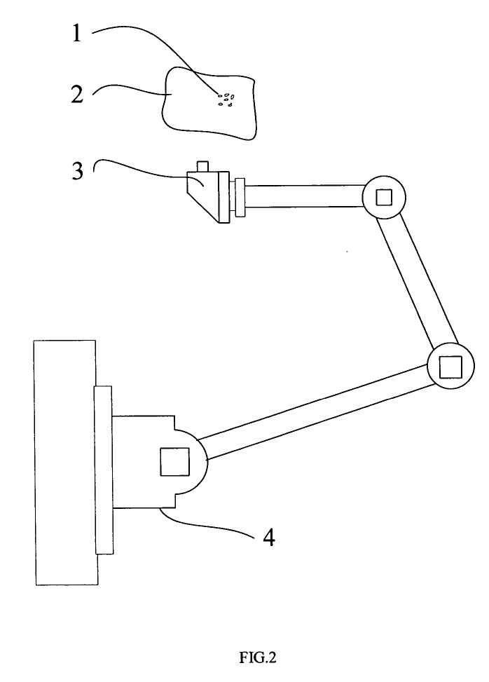

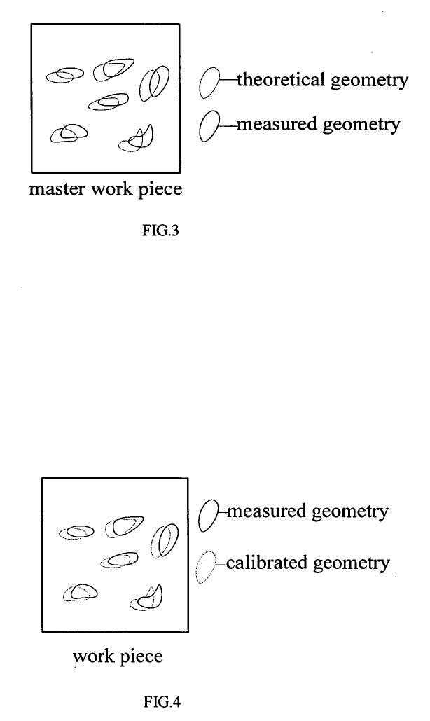

### REFERENCE NUMERALS IN DRAWINGS

1 holes on work piece

2 work piece to be measured

3 means for measuring

4 robot

### DESCRIPTION OF THE PREFERRED EMBODIMENT

As an example we will address a specific process of the cooling hole inspection on a vane or blade in the following. The inspection of the cooling hole on a vane is conducted with a vision system that is mounted on the robot arm. The vision system consists of a laser scanner and a camera. The laser scanner is used to scan a surface around the hole opening. The camera is used to detect the image position of the hole opening.

In the first step the orientation of the hole axis is determined by using alignment algorithm. Then the hole position is determined by intersecting the hole axis with the surface around the hole opening.

The following is an example to illustrate the calibration process.

For a specific working zone on the part (vane) the location of all the holes are measured with very high precision tools within 50 microns tolerance.

The results are formed as the theoretical data set M1 and are listed as follows

$$M 1 = [ \begin{matrix}- 98.6000 & - 102.5325 & - 75.4425 & - 73.9980 & - 49.0867 \\ 89.8775 & 142.8750 & 83.6950 & 145.1480 & 73.8033 \\ - 26.8625 & - 21.8225 & - 48.4525 & - 50.4000 & - 66.6400 \\ 1.0000 & 1.0000 & 1.0000 & 1.0000 & 1.0000\end{matrix} ]$$

The measured results with the vision system and robot are formed as the calibration data set M2 and are listed

$$M 2 = [ \begin{matrix}- 98.7050 & - 102.8150 & - 75.6650 & - 74.5875 & - 49.9175 \\ 90.6100 & 143.5625 & 84.4650 & 145.8400 & 73.8033 \\ - 26.8625 & - 21.8225 & - 48.4525 & - 50.4000 & - 66.6400 \\ 1.0000 & 1.0000 & 1.0000 & 1.0000 & 1.0000\end{matrix} ]$$

The transformation between two sets of data is the calibration matrix for this specific zone. It is determined by the following relations
T12=M2*pinv(M1)
Where pinv is the persuade inverse of the matrix.

$$T 12 = [ \begin{matrix}0.9466 & - 0.0047 & - 0.0452 & - 6.1049 \\ 0.0262 & 0.9988 & 0.0261 & 4.1184 \\ 0.0234 & 0.0014 & 1.0192 & 2.8641 \\ 0 & 0.0000 & - 0.0000 & 1.0000\end{matrix} ]$$

The difference after transform (fitting error) will be

$$M 2 - T 12 * M 1 = [ \begin{matrix}- 0.0544 & 0.0349 & 0.0596 & - 0.0298 & - 0.0103 \\ 0.0058 & - 0.0037 & - 0.0064 & 0.0032 & 0.0010 \\ 0.0644 & - 0.0413 & - 0.0706 & 0.0353 & 0.0122 \\ 0.0000 & 0.0000 & 0.0000 & 0.0000 & 0.0000\end{matrix} ]$$

Place a work piece on the same location as the master piece, do the measurement with the vision system for the corresponding holes. The measured results are

$$M 3 = [ \begin{matrix}- 98.71 & - 102.82 & - 75.62 & - 74.48 & - 49.90 \\ 90.51 & 143.46 & 84.56 & 145.74 & 74.70 \\ - 26.62 & - 21.51 & - 48.24 & - 49.91 & - 66.10 \\ 1.0 & 1.0 & 1.0 & 1.0 & 1.0\end{matrix} ]$$

The corrected position will be

$$\begin{matrix}M {3}^{ ′} = pinv ( T 12 ) * M 3 \\ = [ \begin{matrix}- 98.6599 & 102.4988 & - 75.3354 & - 73.9111 & - 49.0798 \\ 89.7829 & 142.7663 & 83.7830 & 145.0459 & 73.6967 \\ - 26.7929 & - 21.7655 & - 48.5317 & - 50.2888 & - 66.6428 \\ 1.0000 & 1.0000 & 1.0000 & 1.0000 & 1.0000\end{matrix} ]\end{matrix}$$

What is claimed:

1. A calibration method for improving the accuracy of a robotic measuring system with joint configuration dependent performance, which is based on the fact that the accuracy of a robot can be maintained if the robot has only small joint angle changes, and in the application such as the inspection of cooling hole we can divide hundreds hole into small zones. For each zone the robot can reach all the holes for inspection and machining with small joint angle variations. The calibration is conducted with a master or dummy work piece for all different zones. The method includes the following procedure:
a. A master part or workpiece similar to the workpiece to be inspected is fabricated. The master piece is the one with all the hole locations are known. The location of all the holes on the master work piece is determined precisely. They are considered as the theoretical values.
b. Group all the holes on the working piece into individual zones. In each zone all the hole positions can be inspected with small robot joint angle changes
c. Use the vision system (or other measurement tool) to measure the positions of all the holes on the master piece. First use the vision system to measurement certain geometry feature and create the work object CS based on the measured geometry. All the measurement will be based on this work object CS.
d. Transformation matrix is formed based on measured data set and theoretical data (calibration matrix)
e. A transform matrix is formed based on the measured hole positions and their theoretical values for each individual zone. This matrix will be used to compensate for the measurement error due to the robot tolerance.
f. Measurement of the work piece
Place the work piece under inspection at the same location as the master work piece was. Run the same robotic program to create the work object coordinate system (CS). Measure all the cooling holes on the part. During the measurement try to keep the same robot joint configuration as for the master piece for each individual zone.
g. Correct the measurement results with calibration matrix
Due to the robot error the measured hole positions may not be accurate. The correction is realized by multiplying the measured results by the calibration matrix.

2. The method of claim 1 which includes:
determining the location of said feature with respect to the robot coordinate system after calculating the two types of measuring results.

3. The method of claim 1 which includes:
moving the sensor from an acquisition zone to another with a fixed master or work piece while steps (a)-(1) are executed, or moving the master or workpiece from an acquisition zone to another relative to the sensor while steps (a)-(1) are executed; and
the method for combination all the data from all the zones using coordinate systems involved.

4. The method of claim 1 which includes:
recording the data from the sensor using binary processing after recording said master and part images or data.

5. The method of claim 1 which includes:
establishing an inverse transform for a first measurement of the master;
reading the inverse transform from a memory; and
calculating the center of the vision system in reference to its recording the first image subsequent to calculating the alignment axis and surface plane

6. The method of claim 5 which includes:
correcting the measurement data or the work piece image by using the said inverse transformation matrix obtained from the measurement data of the master.

7. The method of claim 1 wherein the calculation of the geometric features on master and workpiece is effected by coordinate systems used.
